(19) United States
(12) Patent Application Publication
(10) Pub. No.: US 2015/0258481 A1
(43) Pub. Date: Sep. 17, 2015

(54) Modular Gas and Odor Filtering Device and Method

(71) Applicants: Patrick Lemire, Terrebonne (CA); Philippe Micone, Montreal (CA)

(72) Inventors: Patrick Lemire, Terrebonne (CA); Philippe Micone, Montreal (CA)

(21) Appl. No.: 14/375,520

(22) PCT Filed: Jan. 30, 2013
(86) PCT No.: PCT/CA2013/000078

§ 371 Date: Jul. 30, 2014

Related U.S. Application Data
(60) Provisional application No. 61/592,256, filed on Jan. 30, 2012.

(51) Int. Cl. B01D 46/00

(52) U.S. Cl. CPC B01D 46/0038; B01D 46/002; B01D 46/0005; B01D 46/0052

(57) ABSTRACT

Modular Gas And Odor Filtering Device and Method will be described. The Device is configured to float on water of similar liquid surfaces holding a filtering cartridge. The emitted gases from the liquid surface will then initially go through the filter and be imprisoned or degraded. A plurality of modular floating filtering units may additionally be joined together in order to cover a wider surface and allow a more substantial filtration of the emitted gases, thus reducing the odors and/or gas emissions.

### CROSS-REFERENCE TO RELATED APPLICATIONS

The present patent application claims the benefits of priority of U.S. Provisional Patent Application No. 61/592,256, entitled “Gas & Odor Filtering Device” and filed at the United States Patent and Trademark Office on Jan. 30, 2012, the content of which is incorporated herein by reference.

### FIELD OF THE INVENTION

The present invention generally relates to device and method for filtering gases and odor.

### BACKGROUND OF THE INVENTION

In most industries, several liquid waste and non-waste reservoirs require constant management. Several of these reservoirs generate odors due to gases emanating from such liquid wastes. Similarly, a liquid waste and non-waste often results in the emission of substantial amount of toxic gases which require constant capture, filtering and/or monitoring.

Most of the reservoirs are now covered using diverse means. Known methods typically involve covering the liquid surface using solid materials such as geo-textile membranes, rigid aluminum panels or concrete. These methods are not only expensive; they also generally require extra equipments to treat the air trapped by these covers. In order to treat the air, activated carbon filters or chemical scrubbers may be used, along with powerful fans to draw the air through it. Others may sometimes use bio filters or UV degradation instead of the activated carbon filters or chemical scrubbers. However such methods require expensive fans and maintenance to insure proper functioning of the ventilation systems.

Prior art currently employed alternatives to covering the liquids require spraying chemicals in the air over the liquid surface in an attempt to neutralize the odors emanating from such liquid. This type of chemical spraying generally implies a constant usage of mostly health hazards chemicals resulting in expenses for these chemicals along with maintenance of the dispersing system in addition to possible health hazard related to the uses of such chemicals.

In view of the foregoing, there is a need for a gas and/or odor filtering device and related method that mitigate at least some of the shortcoming of prior art devices and methods.

### SUMMARY OF THE INVENTION

The present invention will provide a modular gas & odor filtering device and method that mitigates at least some of the shortcomings of the prior art. The gas and odor filtering device and method are designed from a floating structure in combination with a filtering cartridge wherein the filtering cartridge enables capture and/or filtration of emissions. The present device for filtering gases and odor (also referred to as gaseous emission) emitted by liquid surfaces may be used as a single unit or may be combined with other similar unit as a modular assembly.

The device comprises a frame structure and a filtering cartridge. The frame structure is substantially made from floating materials enabling the device to float on a liquid surface. The frame structure is typically configured to hold the filtering cartridge in its center and above the liquid surface. Such configuration allows the gaseous emissions to reach the filtering cartridge before being emitted into ambient air, thus reducing the perceived odor.

The device in accordance with the principles of the present invention allows the covering of a plurality of liquid surfaces and the filtering of their gaseous emissions embedded in a single device or assembly. Such solution is generally not possible with existing prior art devices as one type of device shall be use with a single liquid surface.

The present invention provides a modular solution for covering a liquid surface and filtering its emissions, thus reducing the construction cost typically involved with existing systems, such as geo-textile, aluminum or concrete offerings. In addition, it allows the treatment of air going through the device by using a passive filtration system. In other words, the device in accordance with the principles of the present invention does not require heavy ventilation system in order to force the air through the filters. The gases, in order to reach the ambient air must substantially go through the filtering means. Generally, the gases will have to go through filtering means such as activated carbon filtering cartridge, saving on expensive ventilation systems and maintenance and avoid using continuous supply of chemicals

The filtering device may be used on numerous types of liquid surface areas such as aerated liquid basins, non-aerated liquid basins, lagoons, anaerobic lagoons, open-air tanks, activated sludge, tailing ponds, aeration ponds, and clarifiers. In some embodiments, the filtering device may be used in many different industries such as, but not limited to, the mining industry, oil sands industries, oil and gas industry, municipal and industrial waste water treatment, agro-food businesses, composting industries, and landfills.

The filtering device may treat the gases emitted by the above mentioned surfaces and may treat and/or capture the odors from these gases. In some embodiments, the device may be unitary to comprise a single floating filtering unit.

In other embodiments, a plurality of floating filtering devices, which may be attached to each other, can be deployed to spread and float across a larger surface.

In typical yet non-limitative embodiments, the filter device is shaped such as to allow modular combination of several filtering devices to be used as a single system. In such embodiments, the filtering device may have a substantially regular hexagonal shape, thereby enabling the device to form a honeycomb-like structure with other devices. The devices may be self assembled on the liquid surface without any attachment means or may be attached as to remain in a desired or required structural form.

According to one aspect of the present embodiment, the number of floating filtering devices to be used in a multi-device system may be function or relative to the amount and/or type of gases emitted by the liquid surface and/or to the filtering power required to filter the unwanted gases. As such, for mildly emitting liquid surfaces, a lower number of different medium in the filtering cartridge or smaller thickness may be used to filter the emitted gases whereas, whereas for higher emitting liquid surfaces, a significantly thicker filtering cartridge and/or different media may be required.

One of the advantages of the filtering device in accordance with the principles of the present invention is the modularity, wherein several devices may be easily assembled into a multi-device system for covering larger liquid surface. The modularity allows the covering of any surface of any size. One skilled in the art will understand that the filtering device in accordance with the principles of the present invention eases the installation of such a device on a water surface of any liquid density. Similarly, the device may adapt to any level of fluid within a certain pool or container and variation of this liquid level through time. Accordingly, as a filtering cartridge may need to be replaced, a filtering device may be easily removed from a multi-device system and replaced by a new device without having to replace other devices, thus minimizing the maintenance costs and the effort required to replace a device. The installation of such a device may be achieved by a single person, and without specific skills. In addition, it is even possible to have a single person responsible for the maintenance of the filtering cartridges.

The present device is typically configured to be assembled in a floating filtering device assembly wherein the assembly comprises a plurality of device. The device would generally naturally fit together on an enclosed fluid surface as to maximize the covering of the liquid surface. Understandably, the covering of the liquid surface will be maximized provided that enough filtering devices are present. The devices are typically attached together via fastening means, such as, but not limited to, screws, nut and bolt, interlocking systems, clamps, hooks or joints. Additionally, for more flexibility, the attached devices may be flexibly attached to one another as to allow movement of the underneath fluid.

The filtering cartridge substantially reduces the concentration of gas and odorous emissions emanating from a fluid surface, especially when the covering of such surface is maximized.

In some embodiments, the device may allow a plurality of filtering cartridges to be stacked on top of one another. In such embodiments, more layer of filtering may be added to increase the efficiency of the system. As an example, the first layer could be a specific filter for treating a first gas X and the second layer could be for treating a second gas Y which remains in a substantial concentration present even after having gone though the first filter layer.

According to another aspect of the invention, for more emitting liquid surfaces, the present invention allows the stacking of multiple devices one on top of the others in order to multiply the layers of filters. Such cases may arise when the first layer is already using the maximum thickness of cartridge whereas there is still a further need for additional filtration.

In some embodiments, the device may be configured such that several devices can be stacked one above the other. Stacked devices may be used for more emitting liquid surfaces in order to multiply the layers of filters. Such cases may arise when the first layer is already using the maximum thickness of cartridge whereas there is still a further need for additional filtration.

Understandably, when deployed as a multi-device system, the plurality of devices may comprise different types of filter cartridge to allow the filtering of different gases and emissions over a single liquid surface.

Other and further aspects and advantages of the present invention will be obvious upon an understanding of the illustrative embodiments about to be described or will be indicated in the appended claims, and various advantages not referred to herein will occur to one skilled in the art upon employment of the invention in practice. The features of the present invention which are believed to be novel are set forth with particularity in the appended claims.

### BRIEF DESCRIPTION OF THE DRAWINGS

The above and other aspects, features and advantages of the invention will become more readily apparent from the following description, reference being made to the accompanying drawings in which:

FIG. 1 is a perspective view of a single filtering device in accordance with the present invention.

FIG. 2 is a side view of a single filtering device in accordance with the present invention.

FIG. 3 is side view of the filtering cartridge in accordance with the present invention.

FIG. 4 is a perspective view of a modular filtering device comprising a plurality of filtering units assembled on a liquid surface in accordance with the present invention.

FIG. 5 is side view of the filtering cartridge in accordance with the present invention showing a plurality of stacked filtering units.

### DETAILED DESCRIPTION OF THE PREFERRED EMBODIMENT

A novel modular gas and odor filtering device and related system and method will be described hereinafter. Although the invention is described in terms of specific illustrative embodiments, it is to be understood that the embodiments described herein are by way of example only and that the scope of the invention is not intended to be limited thereby.

In the present embodiment, the floating filtering device is configured to reduce gaseous emissions of a water or fluid surface. While the foregoing written description of the invention enables a person of ordinary skills in the art to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

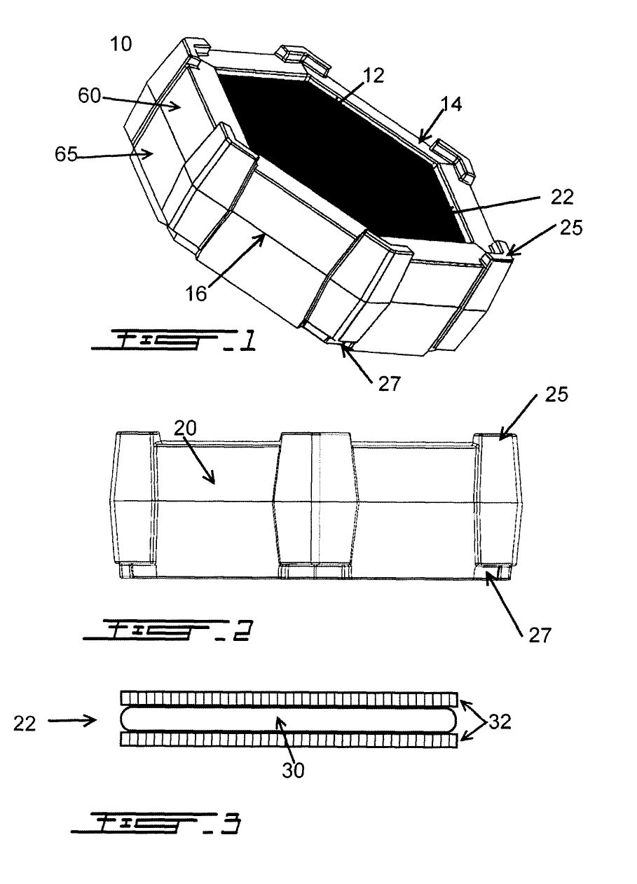

Now referring to FIG. 1, a filtering device 10 in accordance with the principles of the present invention is shown. The filtering device 10 is typically floatable to allow the device to be installed on a liquid surface. The device is generally used to cover a liquid surface. The filtering device 10 comprises a frame 14 and a filtering cartridge 22.

The filtering cartridge 22 is typically attached to the floatable frame 14 of the filtering device 10. The filtering cartridge 22 is typically centrally located on the filtering device 10. The frame 14 is configured such that the filtering cartridge 22 is held above the liquid surface. However, in other embodiments, the frame may be made or constructed with floatable material allowing the floatation of the filtering device 10. The filtering cartridge 22 may be supported by a ledge 16. Such a ledge 16 is typically part of the floatable frame 14. The floating filtering device is generally configured to be assembled with a plurality of other similar floating filtering device forming a filtering assembly.

Still referring to FIG. 1, in the present embodiment, the floating frame 14 may be designed in two parts, the top portion 60 and the bottom portion 65. The top 60 and bottom 65 portions interlock as to allow the filter cartridge 22 to be held in the middle 12 of the modular unit. In order to optimize the space utilized during shipping, the top portion 60 may be designed to allow stacking of one portion into the other. The same may apply to the bottom portion 65; it may stack one portion on top of the other. Accordingly, it is possible to ship each part separately as to use the smaller amount of space possible.

In another embodiments, the floating frame 14 could be made unitary.

Still referring to FIG. 1, the configuration and structural details of the device according to the present invention are presented. The frame 14 is a structural element of the filtering device 10 and may be made of polymeric material (e.g. plastic) or of any other sufficiently rigid and strong material that is sufficiently buoyancy positive. The material of the frame 14 shall also be resistant to the gases, vapors and/or emissions of the liquid surface and be resistant to the content of such a liquid.

Now referring to FIG. 2, the frame 14 comprises a plurality of side walls 20. Each wall of the plurality of side walls 20 is typically shaped to hold the filtering cartridge 22 above the water surface. The filtering cartridge 22 is generally held above the liquid surface as to prevent liquid from obstructing the filtering cartridge 22.

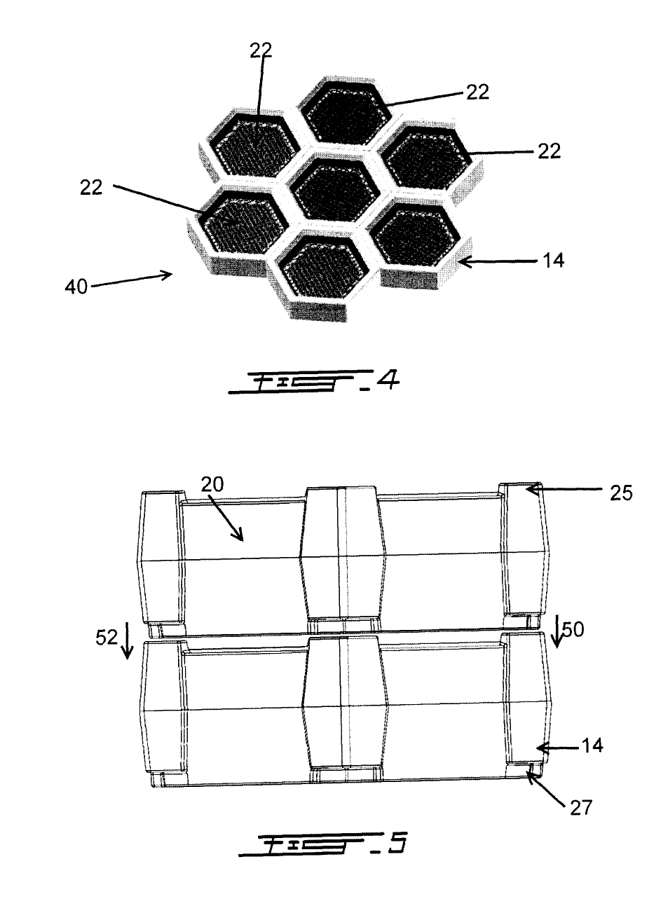

Now referring to FIG. 3, the filtering cartridge 22 is shown as a side view. The filtering cartridge 22 is generally made of a plurality of filtering elements 30 held in place by a plurality of cartridge walls 32, typically two. Each cartridge wall 32 typically comprises one or more openings allowing a substantial volume of air and/or gases to go through. A cartridge wall 32 may hold various thickness of filtering elements 30. The filtering elements 30 may also be composed of various types of materials or mixtures, such as activated carbon, photo-catalytic membrane, organic compound and/or other gas and odor filtering medium. Each filtering element 30 is generally configured to absorb and/or degrade one or more of the gases emitted by the liquid surface.

Now referring to FIG. 4, in another embodiment, a multi-device assembly 40 comprising a plurality of modular filtering devices 10 is shown. Each modular filtering device 10 comprises one or more attachment means enabling the assembly of a plurality modular filtering device 10 with each other. The surface covered by such an assembly 40 is typically related to the volume of gases emitted by the liquid surface. Accordingly, the larger the surface the filtering assembly covers, the higher the volume of gases will be filtered.

One of the advantages of the present device, without limitation, is its modularity. By being able to combine several devices 10 together into a multi-device assembly 40, it is possible to cover a substantial portion of surface of any size. In fact, the covered surface is maximized as the shape of each filtering device 10 fits with adjacent deices 10 as best shown in FIG. 4. Furthermore, an assembly 40 of a plurality of filtering devices 10 eases the installation of a gas and emission filtering system over a liquid surface of any density and allows the replacement of the filtering cartridge when needed. The installation of such an assembly 40 or of a single filtering device 10 may be executed by a single person. Such an assembly 40 of filtering devices 10 will naturally fit together on an enclosed liquid surface to maximize the covering provided that there are enough devices 10. The filtering cartridge will provide a reduction of gas and odorous emissions coming from the surface when the coverage is maximized.

Now referring to FIG. 5, in the present embodiment, the device 10 is configured such that several devices 10 may be vertically stacked one above the other. The number of allowed stacked filtering device 10 is related to the floatation capability of filtering device floating on the liquid surface. To that effect, in an assembly 40 comprising a plurality of filtering devices 10 attached to each another, a larger surface will allow a higher number of devices 10 to be stacked as the floatation or buoyancy of the assembly 40 is increased. Such a stack of filtering devices 10, either installed as an assembly 40 or as a single unit, can provide a plurality of filtering layers, thus increasing the filtering capability or allowing the filtering of different types of gases or emissions. In order to be stackable, a filtering device 10 may comprise an interlocking mechanism 25, 27 build or molded into the floatable frame 14 structures (see also FIGS. 1 and 2). In other embodiments, other mechanisms to allow the stacking of multiple filtering devices 10 may be used.

The vertical stacking of a plurality of filtering devices 10 typically comprises the placement of a device 10 on top of another device 10 and the alignment of the male interlocking members 25 into the female interlocking members 27 along a substantially vertical axis 50, 52.

The filtering device 10 in accordance with the principles of the present invention may generally be used on various types of surface areas, such as, but not limited to, aerated basins, non-aerated basins, lagoons, anaerobic lagoons, open-air tanks, activated sludge, tailing ponds, aeration ponds, and clarifiers. The filtering device 10 in accordance with the principles of the present invention will generally capture and/or treat at least some of the gases being emitted by theses surfaces thereby reducing the odors resulting from such gases.

A method to install and use a filtering device 10 or an assembly 40 of filtering devices 10 is now presented. The method allows one or more filtering devices 10 to be installed on any water or liquid of an open reservoir. A plurality of devices 10 may be placed onto the liquid surface without being assembled. The devices 10 will substantially float on top of the fluid level. Such flotation is especially desired for reservoirs having substantial level variations. As such, the modular device 10 will be leveled with the fluid surface and will filter the gases emanating from such surface. Typically, gases will emanate from the fluid of the surface and reach the filter. The filter will then treat and/or degrade a significant amount of the emanated gases thereby removing the odor resulting from such gases.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1. A device for filtering at least one gaseous emission emitted from liquid surfaces, the device comprising :
a) a frame configured to float on the liquid;
b) a filtering cartridge mounted to the frame.

2. A device as claimed in any of claim 1 or 2, wherein the device is configured to hold different types of filtering cartridges.

3. A device as claimed in any of claims 1 to 3, wherein the filtering cartridge comprises at least one filtering element held in place by at least one cartridge wall.

4. A device as claimed in claim 4, wherein the at least one filtering element is held in place by two cartridge walls.

5. A device as claimed in claim 4, wherein the at least one cartridge wall comprises a plurality of openings.

6. A device as claimed in any of claims 4 to 5, wherein the at least one filtering element is configured to filter a specific type of gaseous emission.

7. A device as claimed in any of claim 5 or 6, wherein the at least one filtering element is made with different materials.

8. A device as claimed in any of claim 6 or 7, wherein the at least one filtering element is made with activated carbon, photo-catalytic membrane, organic compound, or combination thereof.

9. A device as claimed in any of claims 1 to 8, wherein the device is configured such as to be vertically stackable with other devices.

10. A device as claimed in claim 19, wherein the device comprises an interlocking mechanism.

11. A device as claimed in any of claims 1 to 10, wherein the frame is substantially hexagonal.

12. A device as claimed in any of claims 1 to 11, wherein the frame is made with polymeric material.

13. A multi-device assembly comprising a plurality of devices as claimed in any of claims 1 to 12, wherein the each of the plurality of devices is attached to adjacent devices.

14. A method for filtering at least one gaseous emission emitted from a liquid surface, the method comprising:
a) installing a filtering device comprising a floatable frame and a filtering cartridge on the liquid surface;
b) treating, capturing and/or filtering the at least one gaseous emission passing through the filtering cartridge.

15. A method as claimed in claim 14, wherein the filtering cartridge corresponds to the type gaseous emission emitted by the liquid surface.
